(19) United States
(12) Patent Application Publication
(10) Pub. No.: US 2018/0254644 A1
(43) Pub. Date: Sep. 6, 2018

(54) TECHNIQUES FOR CHARGER CONTROL

(71) Applicant: INTEL CORPORATION, SANTA CLARA, CA (US)

(72) Inventors: Hyung Geun Cho, Los Altos, CA (US); David Niemira, Santa Clara, CA (US); Jorge Zabaco, San Diego, CA (US); Jian Li, Santa Clara, CA (US)

(21) Appl. No.: 15/450,399

(22) Filed: Mar. 6, 2017

(51) Int. Cl. H02J 7/00

(52) U.S. Cl. CPC H02J 7/0029; H02J 7/0072; H02J 7/0044

(57) ABSTRACT

Techniques for an electronic device charger are provided. In an example, an apparatus may include a first plurality of interconnects configured to connect with second interconnects of the electronic device, wherein a first interconnect of the first plurality of interconnects is configured to provide charge power to the electronic device, a power transfer circuit configured to receive a supply voltage and to provide the charge power, a first temperature sensor configured to sense a first temperature of one interconnect of the first plurality of interconnects and to provide an indication of the first temperature, and a comparator configured to receive a threshold and the indication of the first temperature and to disable the power transfer circuit if the first temperature violates the threshold.

### TECHNICAL FIELD

Embodiments described herein generally relate to chargers for electronic devices and more particularly for techniques to prevent damage from misuse or unintentional use of the charger.

### BACKGROUND

Depending on a devices application and functions, at least certain components on many portable electronic devices appear to attract consumer interest if the component is smaller than the same component on a competitive device. One such component is the port or interface for a wired charger. However, smaller charger ports typically results in less clearance between interconnects of the ports. Smaller clearance between interconnects of a charger port may result in multiple short circuit situations when attempting to charge the device. Some designs solve this problem by requiring certain mechanical or combinational connectors. Such designs may inconvenience the user in initiating a charging session, may fail and result in the device not being charged, or may be damaged preventing the user from charging a battery of the device until the connector is repaired.

### BRIEF DESCRIPTION OF THE DRAWINGS

FIG. 1 illustrates generally a block diagram of an example charger circuit.

FIG. 2 illustrates generally an example power transfer circuit.

FIG. 3 illustrates generally an example current limit circuit.

FIG. 4 is a diagram illustrating a system including an example charger and an electronic device.

FIG. 5 illustrates generally a flowchart of an example method of operating a charger with a thermal protection circuit.

### DESCRIPTION OF EMBODIMENTS

As discussed above, smaller charger ports or charger interfaces of electronic devices may increase the chance of short circuiting interconnects of the charger port. Such short circuiting may be manifest in unpredictable electrical behavior as well as electrical behavior that may be predicted, quickly sensed and compensated for to prevent damage to the charger. The present subject matter provides techniques for preventing charger damage from short circuit behavior that may not be easily sensed electronically as well as providing a backup to those short circuit situations that should be quickly sensed and managed.

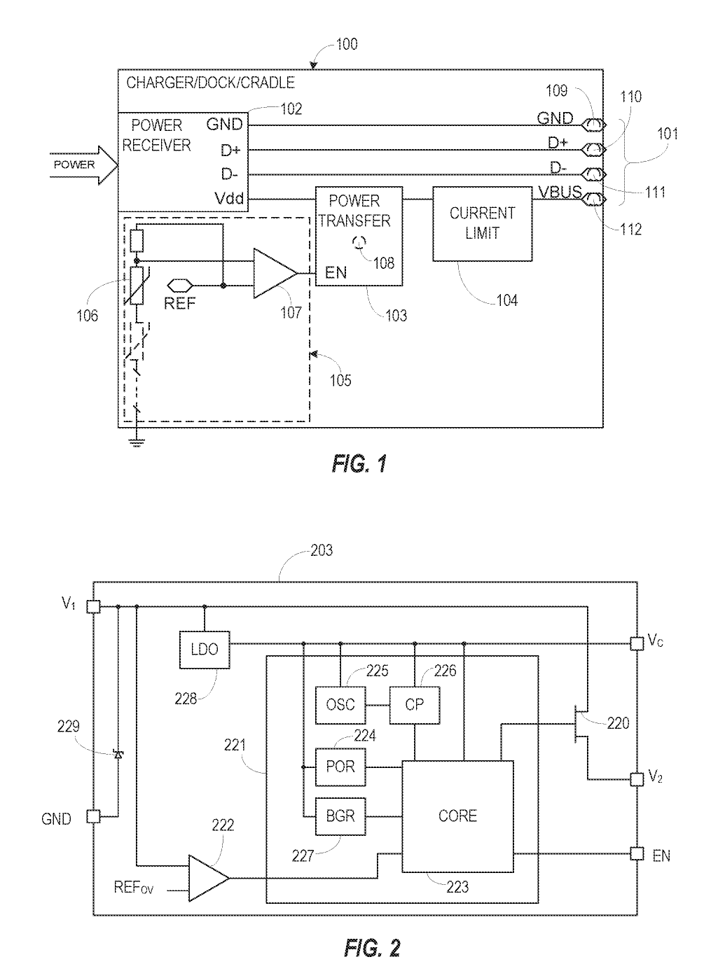

FIG. 1 illustrates generally a block diagram of an example charger or charger circuit 100. In certain examples, the charger circuit 100 may include device interconnects 101, a power receiver circuit 102, a power transfer circuit 103, a current limit circuit 104 and a thermal protection circuit 105. In operation, an electronic device is electrically coupled to the charger via the device interconnects 101. The power receiver circuit 102 may receive supply power and optionally condition the supply power for charging the device, or more precisely, charging a limited energy source of the device such as a battery or capacitor, for example. The power transfer circuit 103 may also condition the power and may protect the charger circuit 100 and the device from power surges. The current limit circuit 104 may limit the current provided to or received from the device, especially during low impedance short circuit events. The thermal protection circuit 105 may monitor, via hardware, one or more temperatures of the charger 100 and shut down the power transfer circuit 103 if a temperature, or a temperature indication, violates a threshold thermal condition, such as, but not limited to, a temperature or indication exceeding a threshold. In some examples, it may be desirable to avoid charging an electronic device when ambient temperatures fall below a certain level. In such examples, the thermal protection circuit 105 may monitor, via hardware, one or more temperatures of the charger 100 and shut down the power transfer circuit 103 if a temperature, or a temperature indication, violates a threshold thermal condition, such as, but not limited to, a temperature or indication falling below a threshold. In some examples, the thermal protection circuit 105 may monitor, via hardware, one or more temperatures of the charger 100 and shut down the power transfer circuit 103 if a temperature, or a temperature indication, violates a threshold thermal condition, such as, but not limited to, a temperature or indication exceeding a first threshold and a temperature or indication falling below a second threshold.

In certain examples, the device interconnects 101 of the charger circuit 100 may be interfaced with the charger interconnects of the device to be charged with out employing a mechanical detent or locking mechanism. In certain examples, the charger circuit 100 may be implemented in a docking station or a cradle. In such examples, the user simply places the device in the dock or cradle and the corresponding interconnects mate to initiate a charging session. In certain examples, contours of the dock or cradle may provide a tactile feedback to the user that the device is properly oriented in the dock or cradle for the corresponding interconnects to mate. Such docks or cradles may be used to charge a variety of mobile electronic devices including wearable electronic devices such as a watch, for example. In certain situations, the device interconnects 101 of the charger circuit 100 may be short-circuited. For smaller electronic devices, the individual interconnects may be located close to each other.

Some electronic devices, such as watches, may include a metal external surface that may facilitate a very low impedance short circuit when in contact with the device interconnects 101 of the charger circuit 100. The current limit circuit 104 is designed to quickly limit current for very low impedance short circuits of a power interconnect. In certain examples, the current limit circuit 104 may provide current at or near the limit value, during a constant current mode of operation, for a predetermined time before providing a fault output. In certain examples, providing current at or near the current limit may cause the current limit to heat-up. In such examples, the current limit circuit 104 may include a thermal protection circuit that may shut down a pass transistor of the current limit circuit if the current limit exceeds a predetermined current limit temperature threshold.

In certain examples, the power transfer circuit 103 may provide charge power at a proper voltage to the electronic device. In some examples, the power transfer circuit 103 may provide over-voltage protection and may include a pass transistor that may regulate the output voltage when the power transfer circuit 103 is receiving power at an over-voltage level. In certain examples, the power transfer circuit 103, upon being enabled via an enable input (EN), may soft start a charging session and prevent power surges that may stress the electronic device or other components of the charger 100. In certain examples, the power transfer circuit 103 may provide bi-directional control of power distribution.

As briefly discussed above, the thermal protection circuit 105 may monitor, via hardware, one or more temperatures of the charger 100 and shut down the power transfer circuit 103 if a temperature violates a threshold thermal condition. Such a thermal protection circuit 105 may be very useful for chargers that are designed to charge electric devices, such a small wearable devices, that have interconnects with very small separation. In order to charge such electronic devices, the charger 100, the dock, or the cradle used to charge the electronic device may also have device interconnects 101 with very small separation distances. The small separation between individual interconnects may increase the probability interconnects may become short circuited. Some of the mechanisms of short circuit may be monitored and the charger 100 may include protective circuits such as a current limit circuit 104 to protect the charger 100 from damage. These predictable mechanisms of short circuits may include very low impedance short circuit events. Other mechanisms of short circuits may sometimes imitate a charging session but may possess a characteristic that may damage the charger 100, for example, when water or other materials short-circuit one or more interconnects. The thermal protection circuit 105 employs one or more temperature sensors that may provide an indication of temperature of a component that may experience thermal stress during an unanticipated short circuit event. The thermal protection circuit 105 may compare the temperature indication of each temperature sensor to a threshold and may, in certain examples, interrupt the charging session of the charger 100 to at least prevent damage to the charger 100.

In certain examples, the temperature sensors may be positioned in one or more optional locations 108, 109, 110, 111, 112 of a charger 100, a charger dock, or a charger cradle. Those optional locations may include, but are not limited to, at or near one or more individual power interconnects 108, 112, at or near one or more individual data interconnects 109, 110, at or near the power transfer circuit 108, 103, or a combination thereof. In certain examples, a temperature sensor 106 may include, but is not limited to, a thermocouple, a resistance temperature detector (RTD), a thermistor 106, silicon bandgap temperature sensor, an infrared temperature sensor or a combination thereof. In the example of FIG. 1, the thermal protection circuit 105 may include a comparator 107 and one or more thermistors 106. The comparator 107 may receive a reference voltage (REF) from a reference voltage generator (not shown) and a sense voltage from a series connection of the one or more thermistors 106. In certain examples, the one or more thermistors 106 may be connected in series between the reference voltage (REF) and ground (GND). As the temperature indication received from the one or more of the thermistors 106 changes, the resistance of each thermistor 106 may change and may change the sense voltage. The illustrated example employs thermistors 106 with a positive temperature coefficient such that as a thermistor 106 senses a higher temperature, the resistance of the thermistor 106 increases. As the resistance of a thermistor 106 increases, the sense voltage provided to the comparator by the series connected thermistors 106 may increase. When the sense voltage exceeds or violates the reference voltage (REF), the output of the comparator 107 may be used to disable the power transfer function of the charger 100. In certain examples, the output of the comparator 107 may be coupled to an enable input (EN) of the power transfer circuit 103 and may disable the power transfer function of the power transfer circuit 103 when the sense voltage violates the reference voltage (REF).

It is understood that certain examples may employ thermistors with negative temperature coefficients without departing from the scope of the present subject matter. It is also understood that the thermal protection circuit 105 may include more than one comparator and that each temperature sensor may be monitored by an individual comparator. In certain examples, a single thermal protection integrated circuit may include the comparator 107 and the reference generator (not shown). In certain examples, the comparator 107 may include hysteresis such that the power transfer function of the charger 100 does not enable until the sense voltage transitions past the reference voltage by a hysteresis interval. In some examples, the hysteresis interval may be hardware programmable. In certain examples, the reference voltage (REF) may be hardware programmable. In some examples, the hysteresis interval and the reference voltage (REF) may be programmable.

FIG. 2 illustrates generally an example power transfer circuit 203. In certain examples, the power transfer circuit 203 may include a power switch 220, control logic 221 and an over-voltage comparator 222. The power transfer circuit 203 is configured to receive a supply power at a supply voltage (VD) and provide a charge power at a charge voltage (VBUS) via the power switch 220. The power transfer circuit 203 may include an enable input (EN) and control logic 221 to start-up, monitor and shutdown power transfer of the power transfer circuit 203. In certain examples, the control logic 221 may include a digital core 223, a power-on reset circuit 224, an oscillator 225, a charge pump 226, a bandgap reference 227 or combinations thereof. The control logic 221 may control the control gate of the power switch 220. In certain examples, upon receiving an enable signal at the enable input (EN), the control logic 221 may begin to pass power from the input (VD) receiving the supply power to a system bus output (VBUS) using a soft start of the power switch 220. In certain examples, the voltage of the system bus may follow the voltage of the supply power to a bus voltage threshold. If the supply power voltage passes the bus voltage threshold, the control logic 221 may regulate the bus voltage using the power switch 220 and an oscillator 225 of the control logic 221.

The over-voltage comparator 222 may provide an indication to the control logic 221 of the status of the voltage (VD) of the supply power. If the supply power voltage (VD) exceeds an over-voltage threshold REFOV, an output of the over-voltage comparator 222 may trigger the control logic 221 to shut down the power transfer function of the power transfer circuit 203, such as by controlling the control node of the power switch 220.

In certain examples, the power transfer circuit 203 may include a low drop-out regulator 228 to receive the supply power and to provide a second output voltage (VC) from the power transfer circuit 203. In certain examples, the power transfer circuit 203 may include a surge clamp circuit 229 coupled to the supply power input to clamp transient signals on the supply power such as electrostatic discharge signals. In certain example, a single integrated circuit may include the low drop-out regulator 228, the surge clamp circuit 229, the power switch 220, the control logic 221, and the over-voltage comparator 222.

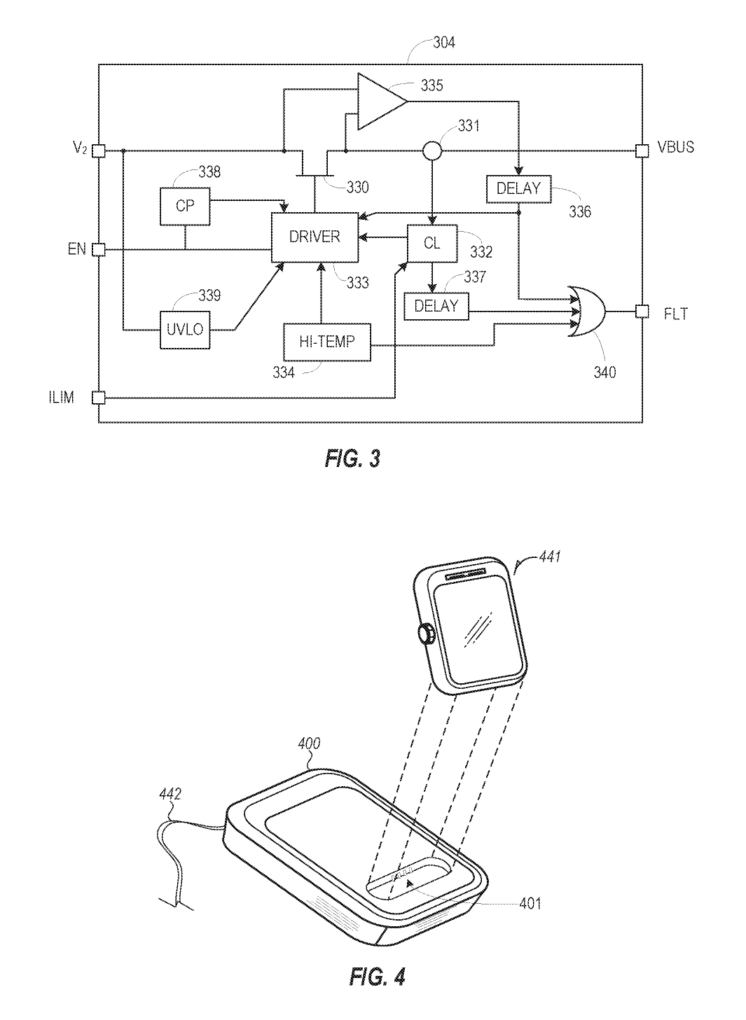

FIG. 3 illustrates generally an example current limit circuit 304. In certain examples, the current limit circuit 304 may include a pass transistor 330, a current sensor 331, a current limit comparator 332, and a driver 333. The driver 333 may receive an enable signal from an enable input (EN) and may turn on the pass transistor 330 to pass charging power from a supply input (V2) to a supply output (VBUS). The current sensor 331 may sense the current passed by the pass transistor 330 and provide an indication of the current level to the current limit comparator 332. The current limit comparator 332 may compare the indication to a current limit threshold (ILIM) and may provide a status of the comparison to the driver 333 via the output of the current limit comparator 332. In certain examples, the driver 333 may control the pass transistor 330 to limit the current at the current limit level (ILIM) in response to the output of the current limit comparator 332.

In some examples, the current limit circuit 304 may include a high-temperature sensor circuit 334 to provide an indication of the thermal stress of the current limit circuit 304 or the thermal stress of the pass transistor 330. The high-temperature circuit 334 may provide an indication of a sensed temperature violating a temperature threshold to the driver 333. The driver 333 may shut down the pass transistor 330 when the thermal stress, or high temperature condition, indicated by the high-temperature circuit 334 has passed the temperature threshold.

In certain examples, the current limit circuit 304 may include a reverse voltage comparator 335 to provide an indication of the polarity of the voltage across the pass transistor 330. The reverse voltage comparator 335 may provide an indication of a reverse voltage condition across the pass transistor 330 to the driver 333. In some examples, the driver 333 may shut down or prevent operation of the pass transistor 330 when a reverse voltage condition is detected.

In certain examples, the driver 333 may provide a fault output (FLT) using an output gate 340, such as a or-gate, when one of an overcurrent condition is detected, a high temperature condition is detected or a reverse voltage condition is detected. In some examples, the current limit circuit 304 may include one or more delay elements 336, 337 such that the fault output is activated for a condition only if the condition remains for the interval associated with the corresponding delay element.

In certain examples, the current limit circuit 304 may include a charge pump 338 for providing a desired voltage to the driver 333. In some examples, the charge pump 338 may be enabled using the signal from the enable input (EN). In certain examples, the current limit circuit 304 may include a under voltage detection circuit 339 to provide an indication of an under-voltage condition of a voltage at the supply input (V2).

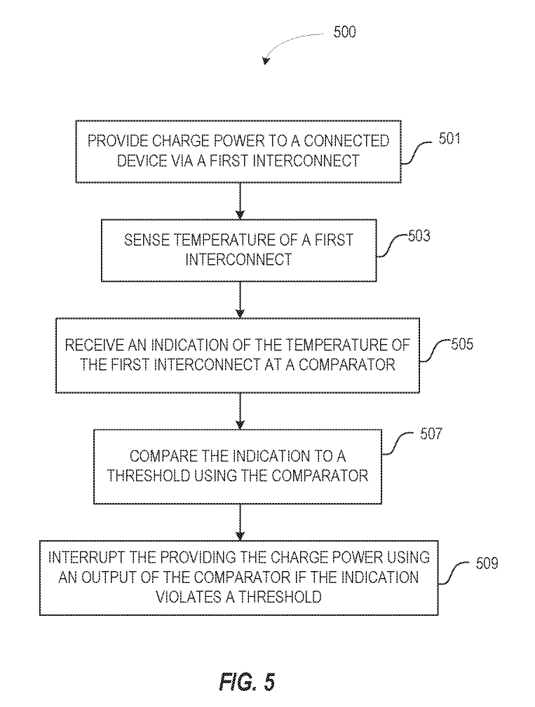

FIG. 4 is a diagram illustrating a system 440 including an example charger 400 and an electronic device, such as a wearable device or a smartwatch 441. The smartwatch 441 may be insertable into the charger 400. The charger 400 may optionally be referred to as a dock or a cradle or a charging stand. The charger 400 may include various functionality of its own (e.g., a radio to communicate with a remote system), or may be merely a power charging station for the smartwatch 441. In certain examples, the charger 400 may include an electric cord 442 to plug into a wall socket and receive power.

In examples where the charger 400 includes additional functionality beyond providing charge power to the smartwatch 441, the charger 400 may be equipped with a display, speakers, buttons, or other input/output mechanisms. Additionally, the charger 400 may include one or more radios and associated subsystems, for example to communicate with the smartwatch 441, or to communicate with a remote system. The radios may allow the charger to communicate over Wi-Fi, cellular, Bluetooth, or other wireless or wired communication systems. For wired connectivity, the charging base 400 may include various interconnects 401, such as interconnects for charging, for an RS-232 port, for a universal serial bus (USB) port, for an Ethernet jack, or the like. For storage, the charger 400 may include its own local memory, such as dynamic random access memory (DRAM), or include a memory card slot, such as to receive a CompactFlash memory card, a Secure Digital card, or the like.

While one example configuration of a charger is illustrated in FIG. 4, it is understood that other form factors and configurations may be used without departing from the scope of this disclosure. In certain examples, the interconnects may provide electrical and data communication characteristics compatible with, but not limited to Micro USB, USB Type A, USB Type-B, USB Type-C, mini-USB, or Apple Lighting).

FIG. 5 illustrates generally a flowchart of an example method 500 of operating a charger with an example thermal protection circuit. At 501, an example charger may provide charge power to a connected device via a first interconnect. In certain examples, the charger may provide current limiting as discussed above using a current limit circuit to protect the charger from damage. In certain examples, the charger may provide surge protection as discussed above with respect to the power transfer circuit. In certain examples, the charger may include ESD protection as discussed above. At 503, a temperature of the first interconnect may be sensed. In certain examples, the first interconnect may be a power interconnect for providing charge power to the connected device. In some examples, the first interconnect may be a data interconnect such as an interconnect for providing USB-compatible data communications. In some examples, the charger may include multiple temperature sensors including temperature sensors for detecting the temperature of the power transfer circuit. At 505, an indication of the sensed temperature may be received at a comparator. At 507, the comparator may compare the indication of the sensed temperature with a threshold and provide an output indicative of the comparison. At 509, if the indication of the sensed temperature violates the threshold, the output of the comparator may be used to interrupt the provision of charge power to the connected device. In certain examples, the output of the comparator may disable functionality of the power transfer circuit to interrupt providing charge power to the connected device.

### Notes and Examples

In Example 1, an apparatus for charging a battery of an electronic device can include a plurality of interconnects configured to the electronic device, wherein at least one interconnect of the first plurality of interconnects is configured to provide charge power to the electronic device, a power transfer circuit configured to receive a supply voltage and to provide the charge power, a first temperature sensor configured to sense a first temperature of an interconnect of the plurality of interconnects and to provide a first indication of the first temperature, and a comparator configured to receive the first indication of the first temperature and to disable the power transfer circuit when the first indication violates a threshold.

In Example 2, the first temperature sensor of Example 1 optionally is a thermistor.

In Example 3, the first temperature sensor of any one or more of Examples 1-2 optionally is a positive thermal coefficient thermistor.

In Example 4, the comparator of any one or more of Examples 1-3 optionally includes a programmable hysteresis.

In Example 5, the apparatus of any one or more of Examples 1-4 optionally includes a current limit protection circuit configured to limit current of the charge power.

In Example 6, the current limit protection circuit of any one or more of Examples 1-5 optionally is configured to provide a fault output when charge power is provided at a current limit for a predetermined interval.

In Example 7, the current limit protection circuit of any one or more of Examples 1-6 optionally is configured to interrupt delivery of charge power to the electronic device to prevent thermal damage of the current limit protection circuit.

In Example 8, the apparatus of any one or more of Examples 1-7 optionally includes a second temperature sensor configured to sense a second temperature of the apparatus and to provide a second indication of the second temperature, and the comparator of any one or more of Examples 1-7 optionally is configured to receive the second indication and to disable the power transfer circuit when the second indication violates the threshold.

In Example 9, the second temperature sensor of any one or more of Examples 1-8 optionally is a thermistor.

In Example 10, the first temperature sensor of any one or more of Examples 1-9 optionally is connected in series with the second temperature sensor between an input of the comparator and ground.

In Example 11, the second temperature sensor of any one or more of Examples 1-10 optionally is configured to sense the second temperature at a second interconnect of the first plurality of interconnects.

In Example 12, the second temperature sensor of any one or more of Examples 1-11 optionally is configured to sense the second temperature at the power transfer circuit.

In Example 13, the subject matter of any one or more of Examples 1-12 optionally includes a third temperature sensor configured to sense a third temperature at a second interconnect of the plurality of interconnects and to provide a third indication of the third temperature, and the comparator of any one or more of Examples 1-12 optionally is configured to receive the third indication and to disable the power transfer circuit when the third indication violates the threshold.

In Example 14 the first temperature sensor, the second temperature sensor and the third temperature sensor of any one or more of Examples 1-13 optionally are connected in series with each other between an input of the comparator and ground.

In Example 15, a method for charging a connected device can include providing charge power to the connected device via at least one interconnect of a plurality of interconnects, sensing a temperature of a first interconnect, comparing a first indication of the temperature of the first interconnect with a threshold, and interrupting the charge power when the first indication violates the threshold.

In Example 16, the providing charge power of any one or more of Examples 1-15 optionally includes receiving a supply voltage at a power transfer circuit, and modulating a power switch of the power transfer circuit to provide the charge power to the connected device.

In Example 17, the interrupting the charge power of any one or more of Examples 1-15 optionally includes disabling the power switch of the power transfer circuit.

In Example 18, the method of any one or more of Examples 1-17 optionally include comparing a second of the temperature of the power transfer circuit with the threshold, and interrupting the charge power when if the second indication violates the threshold.

In Example 19, the method of any one or more of Examples 1-18 optionally includes comparing a third indication of a temperature of a second interconnect with the threshold, and interrupting the charge power when the third indication violates the threshold.

In Example 20, the second interconnect of any one or more of Examples 1-19 optionally is a data interconnect.

In Example 21, the method of any one or more of Examples 1-20 optionally include sensing a current level of the charge power provided to the connected device, comparing the current level to a current limit, and operating a switch of a current limit circuit in a constant current mode when the current level is at least at the current limit.

Example 22 is an apparatus for charging a battery of an electronic device, the apparatus comprising: means for electrically connecting to and for providing charge power to the electronic device; means for receiving a supply voltage and for providing the charge power; means for sensing a first temperature of the means for electrically connecting to the electronic device and for providing an indication of the first temperature; means for comparing a threshold and the indication of the first temperature; and means for disabling the means for providing the charge power if the first temperature violates the threshold.

In Example 23, the subject matter of Example 22 optionally includes wherein the means for sensing a first temperature is a first temperature sensor.

In Example 24, the subject matter of Example 23 optionally includes wherein the first temperature sensor is a thermistor.

In Example 25, the subject matter of any one or more of Examples 23-24 optionally include wherein the first temperature sensor is a positive thermal coefficient thermistor.

In Example 26, the subject matter of any one or more of Examples 22-25 optionally include wherein the means for comparing includes a programmable hysteresis.

In Example 27, the subject matter of any one or more of Examples 22-26 optionally include means for limiting current of the charge power.

In Example 28, the subject matter of Example 27 optionally includes wherein the means for limiting current of the charge power is configured to provide a fault output if charge power is provided at a current limit for a predetermined interval.

In Example 29, the subject matter of any one or more of Examples 27-28 optionally include wherein the means for limiting current of the charge power is configured to interrupt delivery of charge power to the electronic device to prevent thermal damage of the means for limiting current of the charge power.

In Example 30, the subject matter of any one or more of Examples 22-29 optionally include means for sensing a second temperature of the apparatus and for providing an indication of the second temperature; wherein the means for comparing is configured to receive the indication of the second temperature; and to wherein the means for disabling includes a means for disabling the means for providing the charge power if the second temperature violates the threshold.

In Example 31, the subject matter of Example 30 optionally includes wherein the means for sensing a second temperature includes a second temperature sensor.

In Example 32, the subject matter of Example 31 optionally includes wherein the second temperature sensor is a second thermistor.

In Example 33, the subject matter of any one or more of Examples 9-32 optionally include wherein the means for sensing the first temperature sensor is connected in series with the means for sensing the second temperature sensor between an input of the means for comparing and ground.

In Example 34, the subject matter of Example 33 optionally includes wherein the means for sensing the second temperature is configured to sense the second temperature at the means for connecting.

In Example 35, the subject matter of any one or more of Examples 33-34 optionally include wherein the means for sensing the second temperature is configured to sense the second temperature at the means for receiving a supply voltage and for providing the charge power.

Example 36 is at least one machine-readable medium including instructions for implementing thermal protection of a charger, which when executed by a machine, cause the machine to: provide charge power to a connected device via a first interconnect of a plurality of interconnects; sense a temperature of the first interconnect using a first temperature sensor; receive an indication of the temperature of the first interconnect from the first temperature sensor at a comparator; compare the indication of the temperature of the first interconnect with a threshold; and interrupt the charge power if the indication of the temperature of the first interconnect violates the threshold.

In Example 37, the subject matter of any one or more of Examples 1-36 optionally include instructions to provide charge power include instructions to: receive a supply voltage at a power transfer circuit; and modulate a power switch of the power transfer circuit to provide the charge power to the connected device.

In Example 38, the subject matter of any one or more of Examples 1-37 optionally include instructions to interrupt the charge power include instructions to disable the power switch of the power transfer circuit.

In Example 39, the subject matter of any one or more of Examples 1-38 optionally include instructions to: receive an indication of the temperature of the power transfer circuit from a second temperature sensor; compare the indication of the temperature of the power transfer circuit with the threshold; and interrupt the charge power if the indication of the temperature of the power transfer circuit violates the threshold.

In Example 40, the subject matter of any one or more of Examples 1-39 optionally include instructions to: receive an indication of a temperature of a second interconnect of the plurality of interconnects from a third temperature sensor; compare the indication of the temperature of the second interconnect with the threshold; and interrupt the charge power if the indication of the temperature of the second interconnect violates the threshold.

In Example 41, the second interconnect of any one or more of Examples 1-40 optionally is a data interconnect.

In Example 42, at least one machine-readable medium including instructions, which when executed by a machine, cause the machine to perform operations of any of the operations of Examples 1-41.

In Example 43, an apparatus can include means for performing any of the operations of Examples 1-41.

In Example 44, a system configured to perform the operations of any of Examples 1-41.

In Example 45, a method configured to perform the operations of any of Examples 1-41.

In Example 46, a system can include an electronic device and a charger configured to charge the electronic device. The charger can include a plurality of interconnects configured to connect with the electronic device, wherein at least one interconnect of the first plurality of interconnects is configured to provide charge power to the electronic device, a power transfer circuit configured to receive a supply voltage and to provide the charge power, a first temperature sensor configured to sense a first temperature of an interconnect of the plurality of interconnects and to provide an first indication of the first temperature, and a comparator configured to receive the indication of the first temperature and to disable the power transfer circuit when the first indication violates a threshold.

In Example 47, the system of any one or more of Examples 1-46 optionally includes a current limit protection circuit configured to limit current of the charge power.

In Example 48, the current limit protection circuit of any one or more io Examples 1-47 optionally is configured to provide a fault output when charge power is provided at a current limit for a predetermined interval.

In Example 49, the system of any one or more i of Examples 1-48 optionally includes a second temperature sensor configured to sense a second temperature of the apparatus and to provide a second indication of the second temperature, and the comparator optionally is configured to receive the second indication and to disable the power transfer circuit when the second indication violates the threshold.

In Example 50, the system of of any one or more if Examples 1-49 optionally includes a third temperature sensor configured to sense a third temperature at a second interconnect of the plurality of interconnects and to provide a third indication of the third temperature, the comparator optionally is configured to receive the third indication and to disable the power transfer circuit when the third indication violates the threshold, and the first temperature sensor, the second temperature sensor and the third temperature sensor optionally are connected in series with each other between an input of the comparator and ground.

The above detailed description includes references to the accompanying drawings, which form a part of the detailed description.

The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A.” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. An apparatus for charging a battery of an electronic device, the apparatus comprising:
a plurality of interconnects configured to connect with the electronic device, wherein at least one interconnect of the first plurality of interconnects is configured to provide charge power to the electronic device;
a power transfer circuit configured to receive a supply voltage and to provide the charge power;
a first temperature sensor configured to sense a first temperature of an interconnect of the plurality of interconnects and to provide a first indication of the first temperature; and
a comparator configured to receive the indication of the first temperature and to disable the power transfer circuit when the first indication violates a threshold.

2. The apparatus of claim 1, wherein the first temperature sensor is a thermistor.

3. The apparatus of claim 2, wherein the first temperature sensor is a positive thermal coefficient thermistor.

4. The apparatus of claim 1, wherein the comparator includes a programmable hysteresis.

5. The apparatus of claim 1, further comprising a current limit protection circuit configured to limit current of the charge power.

6. The apparatus of claim 5, wherein the current limit protection circuit is further configured to provide a fault output when charge power is provided at a current limit for a predetermined interval.

7. The apparatus of claim 5, wherein the current limit protection circuit is further configured to interrupt delivery of charge power to the electronic device to prevent thermal damage of the current limit protection circuit.

8. The apparatus of claim 1, including:
a second temperature sensor configured to sense a second temperature of the apparatus and to provide a second indication of the second temperature; and
wherein the comparator is configured to receive the second indication and to disable the power transfer circuit when the second indication violates the threshold.

9. The apparatus of claim 8, wherein the second temperature sensor is a thermistor.

10. The apparatus of claim 9, wherein the first temperature sensor is connected in series with the second temperature sensor between an input of the comparator and ground.

11. The apparatus of claim 10, wherein the second temperature sensor is configured to sense the second temperature at a second interconnect of the plurality of interconnects.

12. The apparatus of claim 10, wherein the second temperature sensor is configured to sense the second temperature at the power transfer circuit.

13. The apparatus of claim 12, including a third temperature sensor configured to sense a third temperature at a second interconnect of the plurality of interconnects and to provide a third indication of the third temperature; and
wherein the comparator is configured to receive the third indication and to disable the power transfer circuit when the third indication violates the threshold.

14. The apparatus of claim 9, wherein the first temperature sensor, the second temperature sensor and the third temperature sensor are connected in series with each other between an input of the comparator and ground.

15. A method for charging a connected device, the method comprising:
providing charge power to the connected device via at least one interconnect of a plurality of interconnects;
sensing a temperature of a first interconnect;
comparing a first indication of the temperature of the first interconnect with a threshold; and
interrupting the charge power when the first indication violates the threshold.

16. The method of claim 15, wherein the providing charge power includes:
receiving a supply voltage at a power transfer circuit; and
modulating a power switch of the power transfer circuit to provide the charge power to the connected device.

17. The method of claim 16, wherein the interrupting the charge power includes disabling the power switch of the power transfer circuit.

18. The method of claim 16, including:
comparing a second indication of a temperature of the power transfer circuit with the threshold; and
interrupting the charge power when the second indication violates the threshold.

19. The method of claim 18, including:
comparing a third indication of a temperature of a second interconnect with the threshold; and
interrupting the charge power when the third indication violates the threshold.

20. The method of claim 15, including:
sensing a current level of the charge power provided to the connected device;
comparing the current level to a current limit; and
operating a switch of a current limit circuit in a constant current mode when the current level is at least at the current limit.

21. A system comprising:
an electronic device; and
a charger configured to charge the electronic device, the charger comprising:
a plurality of interconnects configured to connect with the electronic device, wherein at least one interconnect of the first plurality of interconnects is configured to provide charge power to the electronic device;
a power transfer circuit configured to receive a supply voltage and to provide the charge power;
a first temperature sensor configured to sense a first temperature of an interconnect of the plurality of interconnects and to provide an first indication of the first temperature; and
a comparator configured to receive the indication of the first temperature and to disable the power transfer circuit when the first indication violates a threshold.

22. The system of claim 21, including a current limit protection circuit configured to limit current of the charge power.

23. The system of claim 22, wherein the current limit protection circuit is further configured to provide a fault output when charge power is provided at a current limit for a predetermined interval.

24. The system of claim 21, including:
a second temperature sensor configured to sense a second temperature of the apparatus and to provide a second indication of the second temperature; and
wherein the comparator is configured to receive the second indication and to disable the power transfer circuit when the second indication violates the threshold.

25. The system of claim 24, including a third temperature sensor configured to sense a third temperature at a second interconnect of the plurality of interconnects and to provide a third indication of the third temperature:
wherein the comparator is configured to receive the third indication and to disable the power transfer circuit when the third indication violates the threshold; and
wherein the first temperature sensor, the second temperature sensor and the third temperature sensor are connected in series with each other between an input of the comparator and ground.
